(19) United States
(12) Patent Application Publication
(10) Pub. No.: US 2008/0298171 A1
(43) Pub. Date: Dec. 4, 2008

(54) Process for Mixing and Screening Liquid Compositions

(76) Inventors: David Scott Dunlop, Mason, OH (US); Timothy Eaton Laska, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/105,301

(22) Filed: Apr. 18, 2008

Related U.S. Application Data
(60) Provisional application No. 60/928,117, filed on May 8, 2007.

(51) Int. Cl. B01F 7/24

(52) U.S. Cl. 366/314; 366/318

(57) ABSTRACT

A process for mixing one or more liquid compositions comprising the steps of:
a. providing one or more containers for said liquid composition, wherein said container has a volume capacity of from about 10 ml to about 200 ml;
b. filling said one or more container with said one or more liquid composition; and
c. stirring said composition with a helical type mixer at a speed of from about 10 rpm to about 750 rpm;
wherein at least one of said liquid compositions has a viscosity of from about 0.5 Pa-s to about 20,000 Pa-s.

### CROSS REFERENCE TO RELATED APPLICATION

This application claims the benefit of U.S. Provisional Application No. 60/928,117 filed May 8, 2007.

### FIELD OF THE INVENTION

The present invention relates to a process for mixing and screening liquid compositions using a helical mixer.

### BACKGROUND OF THE INVENTION

It is critical to the success of many companies that products can be efficiently sampled and screened. In the case of personal care compositions, sampling and screening costs are dependent on both time for analysis, and volume of the product required for proper analysis. Therefore, in order to reduce costs and increase speed to market, it is desirable to sample and screen small volumes of liquid personal care compositions. Currently marketed personal care compositions comprise a wide array of ingredients. Accordingly, achieving suitable samples, at small volumes of liquid personal care compositions, requires a highly efficient mixing technique.

Pitched Blade Turbine (PBT) type impellers are known for mixing liquid compositions. PBT's can be used to mix large or small volumes of liquids over a range of viscosities. Typically, the rotation speed of the impeller is increased as the volume of liquid is decreased to maintain blending capability. When compositions with low viscosities are mixed at high speeds, the liquid compositions may suffer from aeration due to vortexing and swirling of the liquid. In order to prevent vortexing, baffles are often introduced to the system. However, baffles can create “dead zones” in the mixing tank, which can prevent efficient mixing. As the volume of the system is decreased, PBT's require increasing rotation speeds to effectively mix liquid compositions. Therefore, when PBT's are applied to systems having relatively small volumes, problems with aeration and vortexing are exacerbated.

Various other types of impellers are also known for mixing liquid compositions. Such impellers include modified paddle mixers, anchor mixers, ribbon mixers, and helical mixers. One of several factors considered in choosing a specific type of agitator is the viscosity of the liquid composition being mixed. PBT's are generally preferred for mixing low viscosity compositions. In contrast, helical type mixers are generally applied to high viscosity fluids for mixing purposes. When helical mixers are used in large scale production, they have been found to be undesirable for lower viscosity fluids, as compared to alternative types of mixers. This is especially true for shear thinning fluids. They are generally considered to provide insufficient or inefficient mixing of low viscosity liquids from top to bottom. Sufficient mixing is crucial in assuring that formulations in low volume experimental samples match or predict results in a large scale setting.

Accordingly, there is a need for a process which provides sufficient mixing of low viscosity liquid compositions, with small volumes, without the negatives associated with PBT mixers.

### SUMMARY OF THE INVENTION

The present invention relates to a process for mixing one or more liquid composition, comprising the steps of:
a. providing one or more containers for said one or more liquid compositions, wherein said container has a volume capacity of from about 10 ml to about 200 ml;
b. filling said one or more containers with said one or more liquid compositions; and
c. stirring said composition with a helical type mixer at a speed of from about 10 rpm to about 750 rpm;
wherein at least one of said one or more liquid compositions has a viscosity of from about 0.5 Pa-s to about 20,000 Pa-s.

### DETAILED DESCRIPTION OF THE INVENTION

While the specification concludes with claims that particularly point out and distinctly claim the invention, it is believed the present invention will be better understood from the following description.

Herein, “shear thinning” means a material in which viscosity decreases with the rate of shear.

Herein, “shear thickening” means a material in which viscosity increases with the rate of shear.

Herein, “helical type mixer” means a mixer comprised of a series of mixing elements with the leading edge of one element being perpendicular to the trailing edge of the previous. Each mixing element is configured at about a 180 degree helical twist which may repeat to a desired length. Helical type mixers are known in the art and a preferred type of helical mixer is described in European Patent No. 0,515,852 to Forschner.

Herein, “high throughput screening” means a method of sampling and evaluating an array of product formulations via an efficient, and typically automated, process. The process is generally characterized by time and cost savings relative to traditional analytical methods.

Herein, “dead zone” means a region within a container where movement, agitation, or mixing of a liquid composition is reduced relative to the overall liquid composition.

Herein, “filling” means the transfer of a product or composition into a container. The container need not necessarily reach its volume capacity to be considered “filled”.

The aspects and embodiments of the present invention set forth in this document have many advantages related to mixing low-viscosity liquid compositions using a helical type mixer for relatively small volumes. For example, it has been found that many of the aforementioned negatives associated with PBT mixers are avoided by using helical type mixers for small volumes. Although helical type mixers are well known, they are known to be appropriate for use with high viscosity compositions and in large volumes. Therefore, it has further been found that when a helical type mixer is applied to relatively small volumes, highly desirable mixing results, which cannot be reproduced in large volumes with comparable efficiency.

### Container

The present process involves first providing one or more containers for the liquid composition, which is to be mixed. The container has a volume capacity of from about 10 ml to about 200 ml, more preferably from about 20 ml to about 100 ml, and most preferably from about 30 ml to about 50 ml. It has been found that mixing in small volumes avoids many of the aforementioned negatives associated with PBT type mixers. The container may, for example, resemble a cup, cylinder, or a conical shape. A cup with a rounded base is most preferred to allow the greatest surface area of the helical mixer to be in close proximity to the walls of the container. It has been found that when the blades are in close proximity to the walls of the container, optimal top to bottom mixing occurs. Also, this container design prevents the formation of dead zones, at corners and edges, where the blade would otherwise be unable to cause agitation. Additionally, this configuration maintains uniform heat transfer between the composition and the container walls, which promotes stability and consistency throughout the composition.

### Filling The Container

The second step of the present process is to fill the container with one or more liquid compositions. In the case of multiple liquid compositions, the compositions may have different consistencies. The compositions may be, for example, food products such as creams and sauces, industrial liquids, laundry detergents and fabric softeners, or personal care compositions. Preferably, the compositions are personal care compositions. The one or more liquid compositions my optionally be mixed with a solid or semi-solid materials to create a dispersion or suspension.

Methods for filling liquid compositions into containers are well known in the art, and any such method may be appropriate for the present process.

In one embodiment, more than one container is filled, simultaneously or in succession, during a segment of a high throughput screening or experimentation process. High throughput experimentation and screening techniques are described in U.S. Patent Publication No. 2002/0019009 to Roggen et al. and High Throughput Experimentation, by Chris Hawkins, July 2004.

### Stirring The Composition

The third step of the present process is to mix or stir the composition using a helical type mixer.

Typically, for mixing liquids having a low or medium viscosity, stirring elements are used that have beam-shaped blades positioned at a distance from the wall. Beam-shaped blades generally include propeller type blades as well as PBT's. These elements work well when mixing large scale volumes of liquids. At smaller volumes, higher mixing speeds are typically necessary to sufficiently mix liquid materials. However, increasing mixing speeds can negatively affect the composition being mixed. While helical type mixers have, until now, been reserved for applications involving high viscosity liquid compositions, it has been found that to overcome the negatives associated with increased mixing speeds of small volumes of compositions, helical type mixers provide excellent mixing of liquid compositions having low viscosities, low rotations per minute (rpm), and at low volumes.

The helical mixer herein preferably comprises two stirrer blades, each delimited by two concentric semi-ellipses. Such helical mixers are known in the art. The preferred helical mixer design is described in European Patent No. 0,515,852 to Forschner. The preferred helical mixer comprises at least one stirring element with at least one stirrer blade which is connected to a motor-drivable shaft, and which has the shape of a flat ring segment having an inner and outer peripheral edge, wherein the inner and the outer peripheral of each stirrer blade is formed by part of an ellipse, and in that the stirrer blade has the lowest width at its center and the greatest width at its ends. Such a helical mixer demonstrates highly desirable top to bottom mixing with minimal aeration and vortexing. The mixing blade may be attached to a stirring shaft which may extend downwardly into the container, or extending upwardly from the base of the container. Preferably, the mixing blade attaches to a shaft which extends upwardly from the base of the container, so as to facilitate easier sampling of the mixed product from above.

As mentioned above, as the volume of the liquid system decreases, the mixing speed of known mixing impellers must increase in order provide sufficient mixing. This often results in changes in the sheer of the composition, aeration, and insufficient blending from the top to bottom of the product. Although beam-shaped blades are typically preferred in the art, it has been surprisingly found that at small volumes, and at low rpms, helical type mixers provide highly desirable mixing benefits. Specifically, at the aforementioned small volumes of the container herein, the helical mixer has a rotational speed of from about 10 rpm to about 750 rpm, more preferably from about 20 rpm to about 500 rpm, and most preferably from about 25 rpm to about 200 rpm. Importantly, the ability of the helical mixer to achieve optimal mixing at relatively low rpm has the advantage of minimizing vortexing and aeration associated with PBT's as well as beam-shaped mixing blades in general. In addition, optimal mixing at lower rpms with helical mixers results in the liquid in the container being exposed to a shear rate distribution that is more similar to what might typically be experienced at a larger scale. This provides the advantage of more closely matching processing transformations such as emulsion formation and size. As a collateral benefit, the low rpm recited herein obviates the need for baffles to be introduced to the system.

It is also contemplated that in order to test multiple samples at small volumes, as a segment of a screening technique, multiple samples may be mixed simultaneously or in succession, via an automated process.

### Liquid Viscosity

Useful liquid compositions have a viscosity of from about 0.5 Pa-s to about 20,000 Pa-s, more preferably from about 0.5 Pa-s to about 5,000 Pa-s, and most preferably from about 0.5 Pa·s to about 2,000 Pa-s. As mentioned above, helical type mixers are typically used for high viscosity liquid compositions. This is generally to compensate for the lack of engagement of all zones of the composition as viscosity increases. The blades of helical mixers show improved efficiency at mixing such compositions, over mixers with beam shaped blades.

It is also important to recognize that viscosity may change for many liquid compositions during the stirring step of this process. This is true if, during processing, ingredients are added to the liquid composition which modifies the composition's texture and viscosity. This is especially true for shear thinning and shear thickening compositions. Personal care compositions are typically shear thinning, and accordingly are preferred. Therefore, the aforementioned viscosity ranges apply to both shear thinning and shear thickening compositions, whose viscosities are dependent on shear stress during the stirring step. Based on the foregoing, the aforementioned viscosity ranges apply to liquid compositions which have viscosities within the recited ranges at any time during the stirring step.

As mentioned above, the viscosity for shear thinning and shear thickening fluids is not constant at different shear rates. For shear thinning liquids, higher shear rates result in lower apparent viscosity. In order to account for these variations, viscosity is determined at different shear rates from a theological flow curve. A TA AR-2000 rheometer is used to measure shear rate from 0.1 to 300/s over 3 minutes. This is performed at 25° C. A typical test is conducted with cone and plate geometry where the cone is 4 cm in diameter, has a 2 degree angle, and about a 150 micron gap.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for mixing one or more liquid compositions comprising the steps of:
a) providing one or more containers for said one or more liquid compositions, wherein said container has a volume capacity of from about 10 ml to about 200 ml;
b) filling said one or more containers with said one or more liquid compositions; and
c) stirring said composition with a helical type mixer at a speed of from about 10 rpm to about 750 rpm;
wherein at least one of said one or more liquid compositions has a viscosity of from about 0.5 Pa-s to about 20,000 Pa-s.

2. A process according to claim 1, wherein said one or more containers have a volume capacity of from about 30 ml to about 50 ml.

3. A process according to claim 1, wherein said one or more liquid compositions comprise a personal care composition.

4. A process according to claim 1, wherein said one or more containers each comprise a stirring shaft, wherein said stirring shaft extends upwardly from the base of said one or more containers.

5. A process according to claim 1, wherein said helical type mixer rotates at a speed of from about 25 rpm to about 200 rpm.

6. A process according to claim 1, wherein said one or more liquid compositions have a viscosity of from about 0.5 Pa-s to about 5,000 Pa-s.

7. A process according to claim 1, wherein said one or more liquid compositions have a viscosity of from about 0.5 Pa-s to about 2,000 Pa-s.

8. A process according to claim 1, wherein said helical type mixer comprises at least one stirring element with at least one stirrer blade which is connected to a motor-drivable shaft, and which has the shape of a flat ring segment having an inner and outer peripheral edge, wherein in that the inner and the outer peripheral of each stirrer blade is formed by part of an ellipse, and in that the stirrer blade has the lowest width at its centre and the greatest width at its ends.

9. A process according to claim 1, wherein said one or more containers comprises more than one container, which are filled as a segment of a high throughput screening or experimentation process.
